(19) United States
(12) Patent Application Publication
(10) Pub. No.: US 2007/0067553 A1
(43) Pub. Date: Mar. 22, 2007

(54) Design of a signal switch

(75) Inventor: Chi-Tung Chang, Taipei City (TW)

Correspondence Address: Chi-Tung Chang, 3620 168th St., Apt. 3D, Flushing, NY, 11358, US

(73) Assignee: Alcor Micro, Corp.

(21) Appl. No.: 11/216,649

(22) Filed: Sep. 1, 2005

(51) Int. Cl. G06F 13/00

(52) U.S. Cl. 710/316

(57) ABSTRACT

The present invention provides an improved design of the signal switch, wherein the signal switch comprises at least one combinational logic such as a chip, a plurality of hosts and at least one set of input control device such as a keyboard and a mouse. The chip can further comprise one or more virtual keyboard controller and a plurality of hubs and a multiplexer. The multiplexer of the present invention is utilized to detect and interpret signals. The present invention utilizes the combinational logic design of the chips and the multiplexer to provide a signal switch that can share multi-upstream devices but less downstream ports, only one set of keyboard and mouse is required. Multiplexing downstream devices among multiple hubs, which are dedicated to upstream hosts, help reducing the whole enumeration process of time. The signal switch of the present invention provides an improved design by replacing the central processing units (CPU) of a conventional design of signal switch with the combinational logics such as chips in order to increase the speed of the enumeration, as a result, the enumerating time is thus reduced.

### BACKGROUND OF THE INVENTION

1. Field of Invention

The present invention relates generally to a signal switch system utilizing various chips and a multiplexer. More particularly, the present invention relates to an improving design of a signal switch that is software driver-free and its enumerating time is reduced.

2. Description of the Related Art

Present-day society increasingly relies on computers, computer systems, computer software applications and computer devices as computers become more essential in everyday life. With the increasing demands of computer applications in various areas, the utility and usefulness of computers increase, and integrated circuit (IC) connections become more complex. Various techniques have been developed to increase computer devices connections while providing a more compact computer with high performance.

Devices such as various signal switches are used to share a plurality of output devices, such as computer hosts. The signal switch is designed to provide a switching system that few signal input devices, such as keyboard—mouse and output device, such as monitor, are required to interact with the plurality of upstream hosts. The current signal switch devices, such as the one shown in FIG. 1, are available on the market utilizing central processing units (CPU) to detect and convert the signals. Refer to FIG. 1, the embedded CPU inside the conventional signal switch are downloaded with particular firmware (FM) that restricts its connection to certain signal input devices. In other words, for those signal input devices to be able to connect to the signal switch, they have to comply with the FM that run by the CPU. The utilization of the embedded CPU in the conventional signal switch is required to install a specific firmware within the CPU before the signal switch is put on shelf. If any signal input device that is incompatible with the FM of the CPU, either the FM of the embedded CPU needs to be altered or the type of the input device needs to be changed, it is clearly obvious inconvenience to the user. Therefore, the compatibility of the conventional signal switch such as the one shown in FIG. 1 is very low as it is restricted to certain types of signal input device. Furthermore, those conventional signal switches that require specific firmware to be installed in the embedded CPU in order to operate its driver of the signal switches induce another problem: its reliability. Once particular software is installed in the CPU, different type of signal input devices, may not be compatible to interact with the CPU fairly well. In other words, the signal switch may still functions but performs poorly due to its poor compatibility. A particular software installed within the CPU may allow only certain types of signal input devices to be able to interact or operate with the signal switch. The reliability of the conventional signal switch is then reduced drastically due to its subjection to certain limitations. Therefore it induces inconvenience for the users to restrict to certain types of input control devices that can be connected to the signal switch.

Furthermore, those current conventional signal switches utilize the CPU to detect and convert the signals, the enumeration process of the system would require longer time to abstract or detect signals of the devices.

As a result, the present invention provides a new design to improve the current signal switch that provides reliable connections, reduces enumerating time and requires less discrete components.

### SUMMARY OF INVENTION

It is an object of the present invention to provide an improved signal switch utilizing, at least, one combinational logic, such as one or more chips, and a multiplexer, suitable for sharing a plurality of hosts. The present invention provides a design that is contrary to those prior art's designs of utilizing the CPU within the conventional signal switches. The present invention utilizes different types of chips and multiplexer in an improved signal switch in order to detect and interpret signals so that the connections between the plurality of hosts and an input control device can be controlled or altered. The multiplexer of the switch system of the present invention is connected to the plurality of hosts and the input controlling device, wherein the ICs of the multiplexer can determine which one of the hosts is currently connected to the multiplexer. It is another object of the present invention to provide an improved design of the signal switch that can reduce the enumerating time and no specific device driver software is required to install to operate the signal switch. The improved signal switch comprises a first chip, a plurality of hosts and at least one set of keyboard and mouse. The first chip further comprises a plurality of second chips and a plurality of hubs and a multiplexer. The multiplexer of the present invention is utilized to detect and interpret signals. The present invention utilizes the design of the chips and the multiplexer to provide a signal switch that can share multi-upstream devices but less downstream ports, only one set of keyboard and mouse is required. By having a dedicated hub connected to each upstream host would require less enumeration time, which comprise the configuration of a hub and its descendant devices. The signal switch of the present invention provides an improved design by replacing the central processing units (CPU) of a conventional design of signal switch with the chips 100 & 111′-114 in order to increase the speed of the enumeration, as a result, the enumerating time is thus reduced. Since there is no CPU installed in the signal switch of the present invention, therefore, no need to install a device driver and/or firmware under specific software in order to operate the switching system.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the descriptions, serve to explain the principles of the invention. In the drawings,

FIG. 1 shows a block diagram of a conventional signal switch of the prior art;

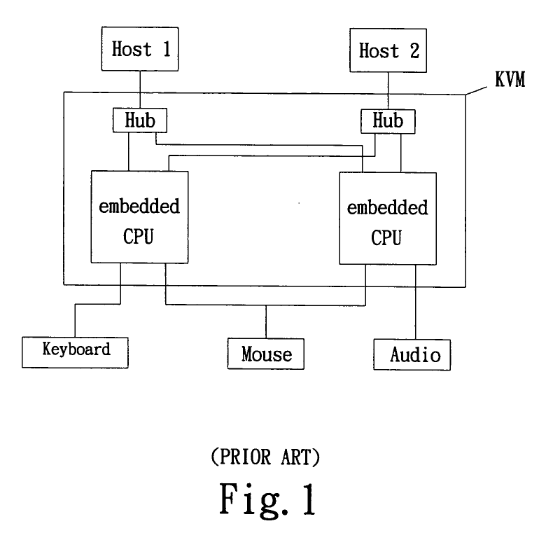

FIG. 2 shows a bock diagram of a signal switch in accordance with a preferred embodiment of the present invention.

### DESCRIPTION OF THE PREFERRED EMBODIMENTS

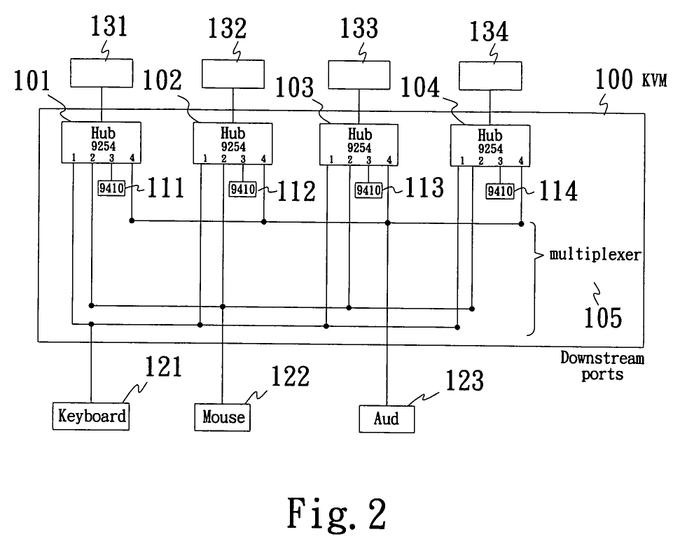

The present invention provides an improved design of a signal switch, suitable for sharing a plurality of hosts and at least one set of keyboard, mouse and video. Refer to FIG. 2, a signal switch 10 utilizing at least one combinational logic such as a first chip 100 to sending and receiving signals, suitable for sharing a plurality of hosts 111-114. However, the design/objects of the present invention is/are not limited to utilization of chips or restricted to the number of chips mentioned in this embodiment. The improved signal switch of the present invention comprises at least one combinational logic, wherein each combinational logic further comprises a first chip 100, a plurality of second chips 111-114. A set of input controlling device can be such as, a keyboard 121, a mouse 122 is connected to each combinational logic, in addition to an output device, such as a video 123. The first chip 100 further comprises a plurality of hubs 101-104 and a multiplexer 105. One end of every host is connected to the hubs, such as a hub 101 is connected to a host 111. Ends of the each hub 101-104 provide upstream ports and downstream ports, wherein the upstream ports of the hubs 101-104 are connected to the hosts 131-134 respectively, and the downstream ports of the hubs 101-104 are connected to the multiplexer 105 and the keyboard and the mouse 121-123. The second chips 111-114 can be called virtual keyboard controllers and are utilized to control connections between the hosts 131-134 and the hubs 101-104. The first chip 100 and the second chips 111-114 control the connecting ports by sending signals to the multiplexer 105.

The improved design of the signal switch of the present invention allows all the hosts connected to the signal switch to share the connected the peripheral devices. The multiplexer 105 of the present invention is utilized to control the connections between the upstream ports and the downstream ports by interpreting those signals. The present invention utilizes the design of the chips 100 & 111-114 and the multiplexer 105 to provide a signal switch that can share less downstream ports, such as only one set of keyboard and mouse is required. Multiplexing downstream devices among multiple hubs, which are dedicated to upstream hosts, help reducing the whole enumeration process of time. In other words, the signal switch of the present invention provides an improved design by replacing the central processing units (CPU) of a conventional design of signal switch with the chips 100 & 111-114 in order to increase the speed of the enumeration, as a result, the enumerating time is thus reduced. In current case, the chips and the multiplexer of the present invention are used to convert and abstract signals generated from universal serial bus (USB).

One of the functions of the multiplexer 105 is to interpret the signal sent by the chips 111-104 in order to decide which one of the hosts 131-134 is connected to the keyboard and the mouse or video, wherein the design of the signal switch of the present invention allows one of the hosts connected to one set of keyboard and mouse each time so that the input control devices such as the keyboard or the mouse can be utilized to share and centralized control the plurality of the hosts. Therefore, less power and less space are required in a computing environment.

The utilization of the combinational logics such as, chips 100 & 111-114, in the signal switch of the present invention is to allow the signal switch to utilize USB as its upstream and downstream interface. The improved design of those chips in the signal switch allows the USB to be used as interface in order to support its driver-free and plug-n-play features. As a matter of fact, the present invention provides a signal switch with features that can allow the user to easily install the switch and use the keyboard and the mouse.

As mentioned above, the signal switch of the present invention utilizes chips 100 & 111-114 instead of CPU, an enumerating time required for the hosts to abstract identities of the downstream devices is thus reduced. Without using the CPU in the signal switch, the signal switch of the present invention does not require specific software to be downloaded or installed in order to operate the system within the switch. The chips and the multiplexer of the present invention can convert and control signals from the USB or to detect signals generated from the Hot-Key of the keyboard. The signal switch of the present invention is designed to combine with the programs within the hosts, such as a Microsoft program, to determine and communicate with the USB ports to various types of keyboards or mouse. Therefore, the signal switch of the present invention can be plugged and played with different kinds of downstream devices without requiring specific software to be installed.

The chips 111-114 of the signal switch 10 can control the connections between the hubs 101-104 and the keyboard or the mouse or the video 121-123 by sending signals to the multiplexer 105, wherein the multiplexer 105 interprets the signals and determine which hubs 101-104 is connected to the keyboard, mouse and video 121-123. The signal switch of the present invention can utilize light emitting diode (LED) indicators to indicate which one of hosts 131-134 is currently connected to the keyboard, the mouse or the video. However, the signal switch of the present invention does not limit to the design of the LED indicators, other similar devices can be utilized. Due to the improved design of the chips 100 & 111-114 and the multiplexer 105, the signal switch 10 of the present invention provides a system that once a connection is established between one of the hosts 131-134 and the keyboard/mouse in the first place, it does not need to redo keyboard 121 and mouse 122 detection again. Therefore, the switching time required to operate from one host to another host is reduced and user can switch amongst those hosts 131-134 easily. The data within the hosts 131-134 will not be lost due to the disconnection or reconnection. In other words, once the user is utilized one of the hosts 131-134, an exiting connection between one of the hosts and the input control devices such as the keyboard 121 or the mouse 122 is established and the information is stored within the system. Furthermore, the keyboard 121 of the signal switch 10 induces different modes of the key sequence to allow the user to switch from one host to another one by utilizing the Hot-Key defined in the keyboard 121.

The virtual keyboard controller/chips 111-114 will determine which host is currently connected through the hubs 101-104 then to the downstream device, and determine when to switch from one host to another. The multiplex identifies and interprets signals generated from the keyboard 121 or the mouse 122 to operate the switching function. It is one of the objects of the present invention to provide a signal switch consisting reliable and driver free features. The replacement of the CPU of the present invention allows the signal switch to have less enumerating time and no driver's software installation is required in the system.

Other embodiments of the invention will appear to those skilled in the art from consideration of specification and practice of the invention disclosed herein. It is intended that the specification and examples to be considered as exemplary only, with a true scope and spirit of the invention being indicated by the following claims.

What is claimed is:

1. An improved signal switch utilizing at least one combinational logic, suitable for sharing a plurality of hosts, the improved signal switch comprising:
the combinational logic having multiplexers and hub devices; and
at least one set of input control devices;
wherein the hub devices of the combinational logic comprise a plurality of hubs, and the hub devices provide ports for upstream devices, in which these upstream ports are connected to a plurality of output devices, one end of the every hub is connected to the combinational logic and to the multiplexer, wherein the multiplexer further provides ports for downstream devices, and the downstream ports are connected to the input control device.

2. The improved signal switch of claim 1, wherein the combinational logic can be a chip.

3. The improved signal switch of claim 2, wherein the chip can further comprise at least another chip called virtual keyboard controller, and the virtual keyboard controller is utilized to determine which one of the hosts is connected to the multiplexer and the input control device.

4. The improved signal switch of claim 3, wherein the virtual keyboard controller of the combinational logic is utilized to create an inactive system by sending false signals to the multiplexer so that once a connection is established between the hosts and the input control device, a detection is not required to redo on the input control device.

5. The improved signal switch of claim 1, wherein the input control device can comprise a keyboard and a mouse.

6. The improved signal switch of claim 1, wherein the signal switch further comprises one or more peripheral device such as, a printer or an audio.
